(19) United States
(12) Patent Application Publication
(10) Pub. No.: US 2016/0136682 A1
(43) Pub. Date: May 19, 2016

(54) NANOPARTICLE COATED SUBSTRATES AND METHOD OF MAKING THE SAME

(71) Applicant: EBO USA INC., Cambridge, MA (US)

(72) Inventors: CHAO-LUN MAI, Cambridge, MA (US); CHU-YUN HUANG, Cambridge, MA (US)

(21) Appl. No.: 14/944,221

(22) Filed: Nov. 18, 2015

Related U.S. Application Data
(60) Provisional application No. 62/081,388, filed on Nov. 18, 2014.
(60) Provisional application No. 62/081,395, filed on Nov. 18, 2014.

(51) Int. Cl. B05D 1/40; B05C 19/04; B05D 7/24

(52) U.S. Cl. CPC B05D 1/40; B05D 7/24; B05C 19/04

(57) ABSTRACT

An apparatus for applying nanoparticles to a surface of a substrate is disclosed. The apparatus includes a support member, a deposition plate extending from the support member, and a platform having a flat surface for receiving a substrate. The support member and the platform are capable of moving relative to each other, enabling an end of the deposition plate to move across the flat surface of the platform.

### FIELD

The subject matter herein relates to nanoparticle coated substrates and a method of coating a substrate surface with nanoparticles.

### BACKGROUND

Thin film technology, wherein organic or inorganic particles with sizes on the order of 1-1000 nm are arranged in layers to form a film, is currently being used for an increasingly large number of different technological applications, including: information storage and transmission systems, chemical and biological sensors, optical and photonic devices, catalytic supports, energy harvesting and storage devices, thermal management devices, and other various products having surface property modification functionalities.

### BRIEF DESCRIPTION OF THE DRAWINGS

Implementations of the present technology will now be described, by way of example only, with reference to the attached figures.

FIG. 1 is a side plan view of an exemplary nanoparticle deposition apparatus.

FIG. 2 is a side plan view of another exemplary nanoparticle deposition apparatus.

FIG. 3 is a diagrammatic view illustrating the application of nanoparticles onto a surface of a substrate using the apparatus of FIG. 1, wherein the deposition plate is contacting a substrate.

FIG. 4 is a diagrammatic view illustrating the application of nanoparticles onto a surface of a substrate using the apparatus of FIG. 1, wherein the deposition plate is suspended above substrate.

FIG. 5 is a free body diagram illustrating forces present during application of nanoparticles onto a substrate.

FIG. 6 is another free body diagram illustrating forces present during application of nanoparticles onto a substrate.

FIG. 7 is a flowchart illustrating an exemplary method of coating a substrate surface with nanoparticles.

FIG. 8 is an exemplary embodiment of a nanoparticle thin film formed on a substrate.

FIG. 9 is a Scanning Electron Microscope (SEM) image of a nanoparticle monolayer disposed on a substrate.

FIG. 10 is an SEM image of another nanoparticle monolayer disposed on a substrate.

FIG. 11 is an SEM image of an exemplary nanostructured substrate surface.

FIG. 12 is an SEM image of another exemplary nanostructured substrate surface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The term “nanoparticles” as described herein, means any particle having a diameter ranging from 1-1000 nm.

The present disclosure is described in relation to an apparatus for applying nanoparticles to a surface of a substrate. The present disclosure is further described in relation methods of using the apparatus disclosed herein for making nanoparticle coated substrates. Nanoparticle coated substrates produced in relation to the disclosed apparatus and methods are also disclosed herein.

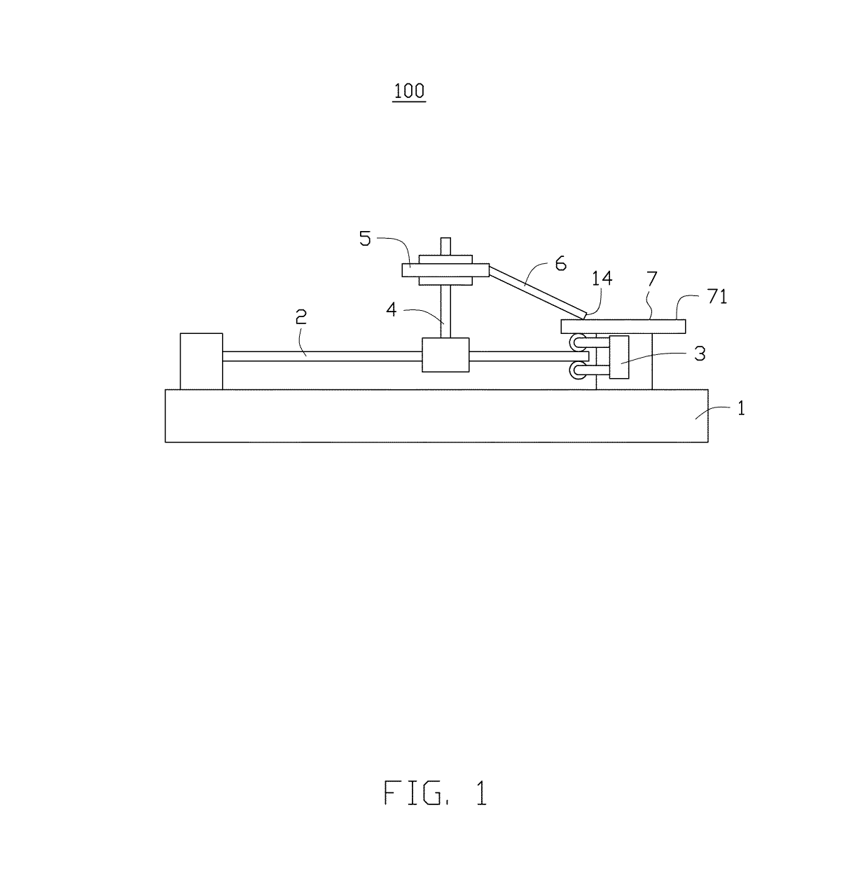

FIG. 1 illustrates an exemplary nanoparticle deposition apparatus 100 for forming a nanoparticle thin film on a substrate. The deposition apparatus 100 generally comprises a support member 4 coupled to a motor 3, a deposition plate 6 extending from the support member 4, a platform 7 having a flat surface 71 for receiving a substrate (not shown), the deposition plate 6 extending toward the flat surface 71 of the platform 7 at an acute angle. The motor 3 is configured to drive the support member 4 toward the deposition plate 6 such that an end 14 of the deposition plate 6 moves across the flat surface 71 of the platform 7, whereby nanoparticles are distributed along the surface of a substrate (not shown) when received on the flat surface 71 of the platform 7. The general components described above are represented in FIG. 1 as follows. As shown in FIG. 1, the deposition apparatus 100 can be mounted on a base 1 to secure the deposition apparatus 100 for use. The deposition apparatus 100 further comprises a drive shaft 2 and a clamp 5. The support member 4 is moveably coupled to the drive shaft 2 and extends perpendicularly from the drive shaft 2. The clamp 5 is mounted on the support member 4. The motor 3 is attached to the base 1. The motor 3 can actuate the support member 4 to move along the length of the drive shaft 2. The motor 3 can be mechanical, electronic, electromagnetic, or any other suitable type of motor. The deposition plate 6 and the clamp 5 can be configured such that the deposition plate 6 couples to the clamp 5. The platform 7 can be coupled to a top surface of the motor 3 for receiving a substrate on which nanoparticles will be deposited.

In use, the deposition apparatus 100 is designed such that a substrate is placed on the platform 7 and the deposition plate 6 extends toward the flat surface 71 of the platform 7 at an acute angle and contacts the substrate surface. Preferably, the deposition apparatus 100 is configured such that the acute angle formed by the substrate and deposition plate 6 is greater than 25 degrees, more preferably greater than 45 degrees, and even more preferably the acute angle is 60 degrees. The acute angle can be changed by, for example, altering the overall height of the support member 4 relative to the platform 7. Alternatively, the acute angle can be changed by moving the clamp 5 to different locations of the support member 4. In other words, as the clamp 5 is moved higher vertically on the support member 4, the acute angle will be increased.

In one embodiment, the deposition apparatus 100 can be used to form a nanoparticle thin film wherein the thin film is a nanoparticle monolayer. In other embodiments, deposition apparatus can be used to form a nanoparticle thin film wherein the thin film has more than one nanoparticle layer.

In at least one embodiment, the deposition plate 6 and clamp 5 can be coupled such that an angle formed between the deposition plate 6 and clamp 5 is constant. In other embodiments, the deposition plate 6 and clamp 5 can be pivotably coupled such that an angle formed between the deposition plate 6 and clamp 5 can be changed prior to or during use. The pivotable coupling can be independently changed by the user or can be changed in response to modification of the support member 4 and the clamp 5 as described above.

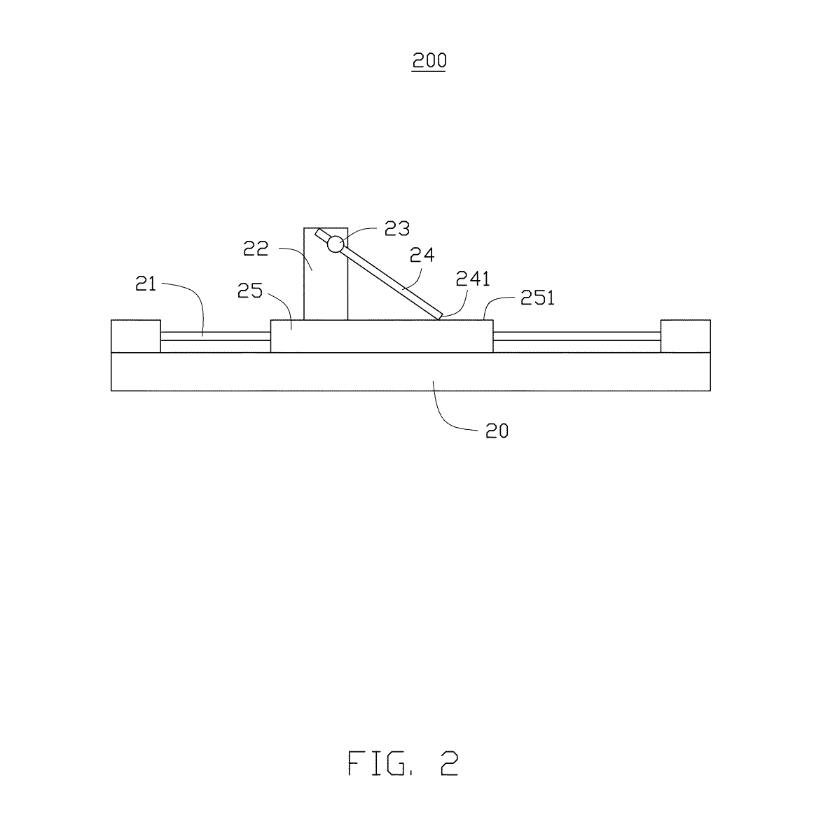

FIG. 2 illustrates another exemplary nanoparticle deposition apparatus 200 for forming a nanoparticle thin film on a substrate. The deposition apparatus 200 generally comprises a platform 25 coupled to a motive force (for example, a motor) via a drive shaft 21 and having a flat surface 251 for receiving a substrate, a deposition plate 24 extending from a support member 22, the deposition plate 24 extending toward the flat surface 251 of the platform 25 at an acute angle. The motive force is configured to drive the platform 25 toward the deposition plate 24 such that an end 241 of the deposition plate 24 moves across the flat surface 251 of the platform 25, whereby nanoparticles are distributed along the surface of a substrate when received on the flat surface 251 of the platform 25. The general components described above are represented in FIG. 2 as follows. As shown in FIG. 2, the deposition apparatus 200 can be mounted on a base 20 to secure the deposition apparatus 200 for use. The platform 25 is moveably mounted on a drive shaft 21. The platform 25 is coupled to a motive force (not shown) which can actuate the platform 25 to move along the length of the drive shaft 21. The motive force can be mechanical, electronic, electromagnetic, or any other suitable type of motor. The deposition apparatus 2000 further comprises a clamping member 23 mounted on the support member 22. The deposition plate 24 and clamping member 23 can be configured such that the deposition plate 24 couples to the clamp 24. The support member 22, which is coupled to the base 20, secures the deposition plate 24 via the clamping member 23.

In use, the deposition apparatus 200 is designed such that a substrate is placed on the platform 25 and the deposition plate 24 extends toward the flat surface 251 of the platform 25 at an acute angle and contacts the substrate surface. Preferably, the deposition apparatus 200 is configured such that the acute angle formed by the substrate and deposition plate 24 is greater than 25 degrees, more preferably greater than 45 degrees, and even more preferably the acute angle is 60 degrees. The acute angle can be changed by, for example, altering the overall height of the support member 22 relative to the platform 25. Alternatively, the acute angle can be changed by moving the clamping member 23 to different locations of the support member 22. In other words, as the clamping member 23 is moved higher vertically on support member 22, the acute angle will be increased.

In one embodiment, the deposition apparatus 200 can be used to form a nanoparticle thin film wherein the thin film is a nanoparticle monolayer. In other embodiments, deposition apparatus can be used to form a nanoparticle thin film wherein the thin film has more than one nanoparticle layer.

In at least one embodiment, the deposition plate 24 and clamping member 23 can be coupled such that an angle formed between the deposition plate 24 and clamping member 23 is constant. In other embodiments, the deposition plate 24 and clamping member 23 can be pivotably coupled to the support member 22 such that an angle formed between the deposition plate 24 and clamping member 23 can be changed prior to or during use. The pivotable coupling can be independently changed by the user or can be changed in response to modification of the support member 24 and clamping member 23 as described above.

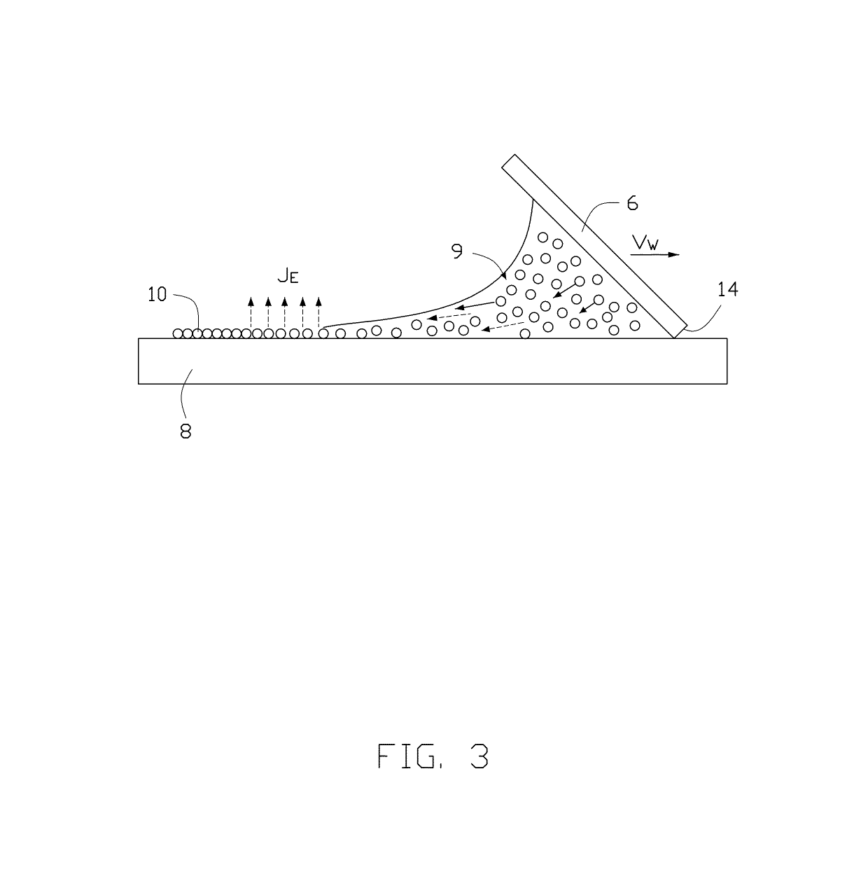

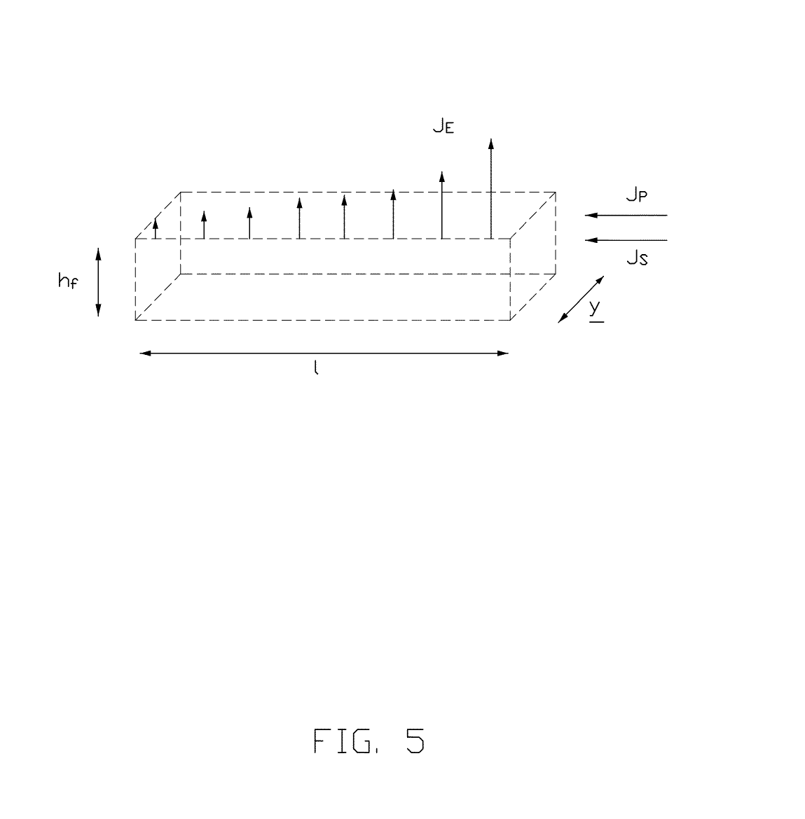

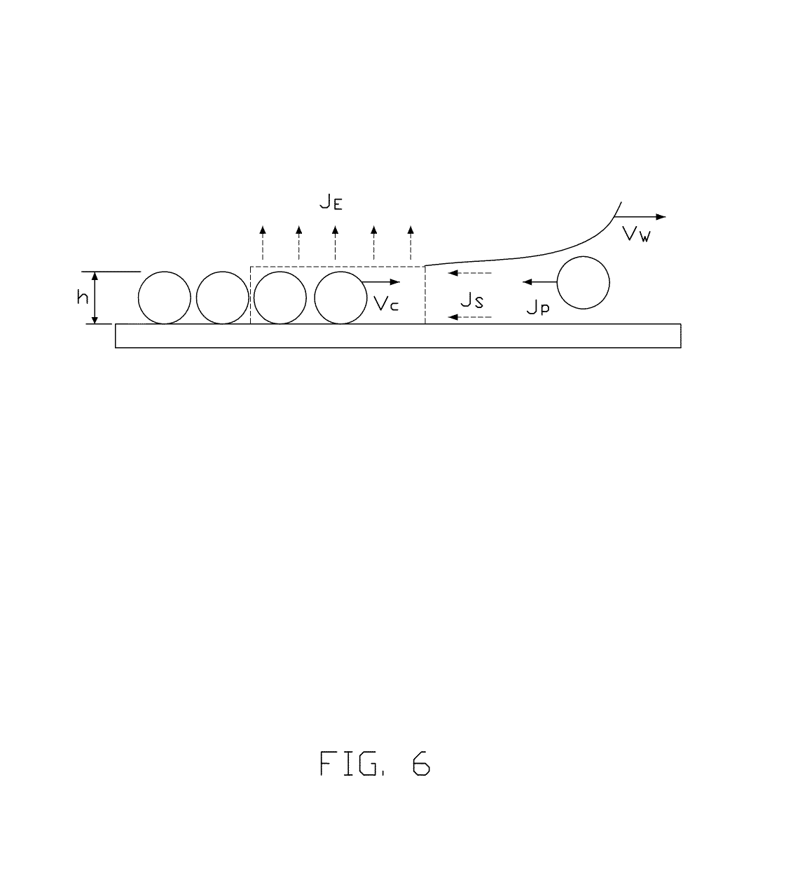

FIG. 3 is a diagrammatic view illustrating the application of nanoparticles onto a surface of a substrate 8. In use, the deposition plate 6 is placed in contact with the substrate 8 at an acute angle. A predetermined amount of a suspension 9 comprising a solvent and nanoparticles is placed in the acute angle formed between the deposition plate 6 and the substrate 8. The suspension 9 is attracted to the surfaces of the deposition plate 6 and the substrate 8 by capillary force. The deposition plate 6 and platform 7 are then moved relative to each other such that the surface of the substrate 8 from the left hand portion of the substrate 8 toward the right hand portion of the substrate 8 at a predefined coating speed V_{w}. As the deposition plate 6 is moved along the substrate 8, the solvent will evaporate as defined by J_{E}, the flux of the evaporating solvent, leaving a nanoparticle thin film 10. The forces and interactions leading to thin film 10 formation are described below in view of FIGS. 5 and 6.

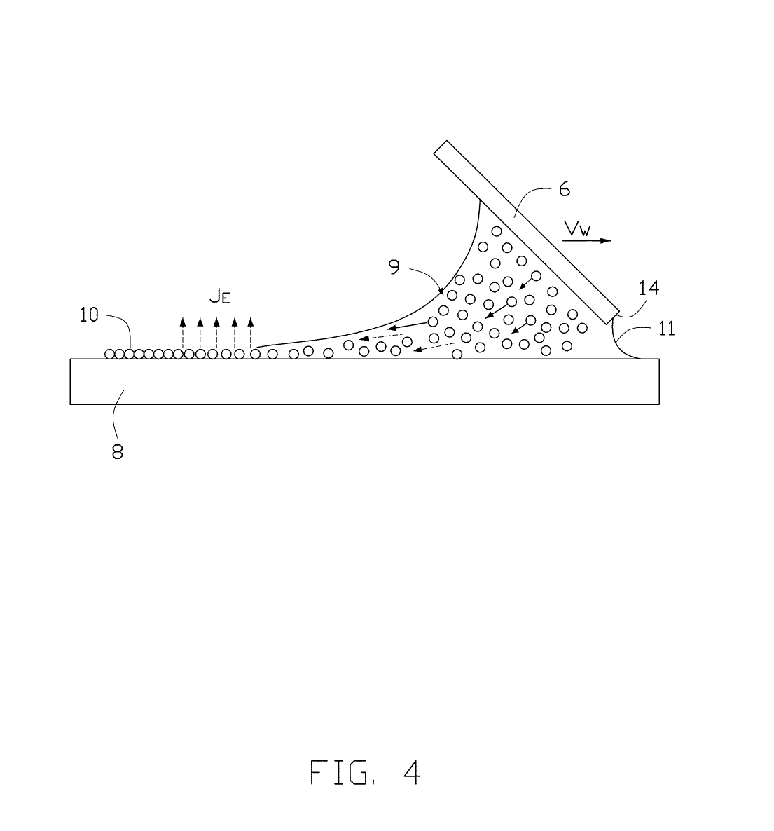

As discussed above, in one exemplary embodiment, the deposition plate 6 physically contacts the substrate 8 when in use as shown in FIG. 3. In alternative embodiments, the deposition plate 6 can be suspended above the substrate 8 at while still forming the acute angle as shown in FIG. 4. In at least one embodiment, the deposition plate 6 is suspended up to 0.5 mm above the substrate 8 surface as shown. In other embodiments, the deposition plate 6 is suspended from about 40 μm to about 0.5 mm above the substrate 8 surface. The deposition plate 6 can be made of a metal, a metal alloy, a silicon oxide, a polymer, a plastic, or any combination thereof.

Also, as shown in FIG. 4, when the deposition plate 6 is suspended above the substrate 8, two opposite meniscuses 11 are formed between the substrate 8 and the deposition plate 6.

The nanoparticles used can be any type of nanoparticles and this disclosure is not intended to be limited for any specific type of application. In some embodiments, the nanoparticles can comprise silicon or silicon oxides. In other embodiments, the nanoparticles can comprise one or more organic polymers or organic dendrites such as polymethyl methacrylate (PMMA), poly carbonate (PC), polystyrene (PS), polyether ether ketone (PEEK), polyetherimide (PEI), or any other similar organic species. In other embodiments, the nanoparticles can be metals or inorganic oxides such as, for example, aluminum, gold, silver, copper, silicon oxide, aluminum oxide, titanium oxide, indium tin oxide, iron oxide, zinc oxide, or any other desired metal or metal oxide composition. In yet other embodiments, the nanoparticles can be core-shell nanocomposites such as zinc sulfide or cadmium sulfide quantum dots, metal nanoparticles or metal oxide nanoparticles coated with an organic polymer or other functionality, or any other similar core-shell type nanoparticle. In yet other embodiments, the nanoparticles can comprise biological species such as proteins, enzymes, immunoglobulins, or any other suitable biological species. In yet further embodiments, the nanoparticles can comprise more than one of any of the nanoparticle type discussed above. The nanoparticles can exhibit properties specific for any use. For example, the nanoparticles can be magnetic, opto-electronic, chemiluminescent, phospholuminescent, any other desired property in application.

The solvent or solvent mixture used can be any type of solvent or solvent mixture and this disclosure is not intended to be limited for any specific type of application. In general, the solvent or solvent mixture should promote uniform dispersion of the nanoparticles in the suspension, be capable of evaporation under ambient or slightly elevated temperature conditions, and facilitate formation of a uniform nanoparticle monolayer. Preferably, deionized (DI) water is used. In alternative embodiments, a polar organic solvent, such as alcohols (for example, methanol, ethanol and isopropanol), dialkyl ethers (for example diethyl ether or diphenyl ether), ketones (for example, acetone) or any similar solvents can be used. In yet further alternative embodiments, mixtures of DI water, methanol, ethanol, diethyl ether, acetone or any similar solvents can be used.

FIG. 5 is a free body diagram illustrating forces present during application of nanoparticles onto a substrate. FIG. 6 is another free body diagram illustrating forces present during application of nanoparticles onto a substrate. The formation of a nanoparticle thin film layer onto a substrate surface can be understood by one of ordinary skill in the art in view of the following equations in relation to FIGS. 5 and 6. The following equations are made with the consideration that a control volume that encompasses a drying region of a thin evaporating film and the control moves as the film dries. The following equations further are modeled under the premise that the y-direction axis does not change and therefore the model can be simplified to a y-independent case. This assumption is especially true for large-area fabrication, where the width of the deposition plate (in y-direction) is large.

In the following equations J_{E} is the flux of the evaporating solvent, J_{P} is the flux of the nanoparticles, J_{S} is the flux of the solvent, y is the unit length of the substrate in the y-direction, Nₛ is the total number density of the solvent molecules, Vₛ is the volume per solvent molecule, vₛ is the flow velocity of the solvent entering the drying region, Nₚ is the total number density of the nanoparticles, Vₚ is the volume per nanoparticle, vₚ is the flow velocity of the nanoparticles entering the drying region, vₑ is the rate of nanoparticle accumulation, ε is the void fraction in the accumulated particle film, h_{f} is the thickness of the control volume, h is the final particle film thickness, φₚ is the volume fraction of nanoparticles in the original suspension undergoing deposition, and β is correlation value.

Under steady state conditions, by conservation of volume:

J_{S}=J_{E} (1)

When the flux of the solvent and the flux of the evaporating solvent are expressed as local average fluxes the following equation can be derived:

J_{S}=y·∫₀^{h}^{_{f}}j′ₛ(z)dz=y·∫₀^{h}^{_{f}}N′ₛ(z)V_{S}v′ₛ(z)dz=jₛh_{f}y

J_{E}=y·∫₀^{∞}j′ₑ(x)dx=jₑly (2)

where

jₛ=NₛVₛvₛ (3)

and

jₚ=NₚVₚvₚ (4)

Under the steady state approximation, the combination of equations 1 and 3 yields:

$${J}_{E} = {j}_{e} l \underline{y} = {j}_{s} {h}_{f} \underline{y} = {J}_{S} , and {j}_{s} = {N}_{s} {V}_{s} {v}_{s} \\ ⇒ \frac{{j}_{e} l}{{h}_{f}} = {N}_{s} {V}_{s} {v}_{s} \\ ⇒ {v}_{s} = \frac{{j}_{e} l}{{N}_{s} {V}_{s} {h}_{f}} \qquad ( 5 )$$

Because there is no exiting flux of, but rather an accumulation of nanoparticle growing at a rate of v_{c}, equation 4 can be expressed as follows:

J_{P}=jₚh_{f}y=NₚVₚvₚh_{f}y, and J_{P}=v_{c}(1−ε)hy (6)

Because the nanoparticles are dispersed in solvent, the nanoparticles will move with the solvent flow. Therefore, the particle flow rate can be considered proportional to the solvent flow rate as follows:

vₚ=βvₖ (7)

and

NₚVₚvₚh_{f}y=NₚVₚβvₛh_{f}y=v_{c}(1−ε)hy (8)

The combination of equations 5 and 8 yields:

$${N}_{p} {V}_{p} β {v}_{s} {h}_{f} = {N}_{p} {V}_{p} β \frac{ {j}_{e} l}{{N}_{s} {V}_{s} {h}_{f}} {h}_{f} = {v}_{c} ( 1 - ɛ ) h \\ ⇒ β {j}_{e} l \frac{{N}_{p} {V}_{p}}{{N}_{s} {V}_{s}} = {v}_{c} ( 1 - ɛ ) h \qquad ( 9 )$$

The ratio of NₚVₚ/NₛVₛ in equation 9 can be rewritten as φₚ(1−φₚ), where φₚ is the volume fraction of particles in the original suspension being deposited, and φₛ=1−φₚ is the corresponding solvent volume fraction, yielding:

$$β {j}_{e} l \frac{{φ}_{p}}{1 - {φ}_{p}} = {v}_{c} ( 1 - ɛ ) h , ⇒ {v}_{c} = \frac{β {j}_{e} l {φ}_{p}}{h ( 1 - {φ}_{p} ) ( 1 - ɛ )} \qquad ( 10 )$$

The correlation value β is dependent upon particle-particle, particle-solvent, or particle-substrate interactions. Since the solvent molecule is assumed to flow more freely than the particle, the value of β is assumed to be in the range of 0-1. Stronger interaction between particles or between the particle and the substrate results in smaller value of β. Also, for non-adsorbing particles and dilute suspensions, β≈1.

Due to the difficulty of determining the jₑ of thin film materials experimentally, βjₑl can be converted to a single variable K, yielding:

$${v}_{c} = \frac{K {φ}_{p }}{h ( 1 - {φ}_{p} ) ( 1 - ɛ )} \qquad ( 11 )$$

For a monolayer of monodisperse spherical nanoparticles oriented in a closed packed hexagonal structure, 1−ε=0.605, and h equals the diameter of the spherical nanoparticles. The single variable K can then be calculated upon determination of v_{c}.

A method of making a nanoparticle coated substrate using the deposition apparatus 100 described above is also provided herein by way of example, as there are a variety of ways to carry out the method. The method described below can be carried out using the configurations illustrated in FIGS. 1 and 3-6, for example, and various elements of these figures are referenced in explaining an example method. The procedure described below is illustrative only and the order of the blocks can change according to the present disclosure. Additional steps may be added or fewer steps may be utilized, without departing from this disclosure.

First a substrate is secured to the platform. After securing the substrate, the deposition plate is placed above the substrate such that an acute angle is formed between the deposition plate and the substrate. Preferably, the acute angle formed by the substrate and deposition plate is greater than 25 degrees, more preferably greater than 45 degrees, and even more preferably the acute angle is 60 degrees. The acute angle is formed at an end of the substrate that is closest to the support member. In at least one embodiment, the deposition plate can be positioned such that it contacts the substrate. In other embodiments, the deposition plate can be suspended above the substrate at while still forming the acute angle. In at least one embodiment, the deposition plate is suspended up to 0.5 mm above the substrate surface. In other embodiments, the deposition plate is suspended from about 40 μm to about 0.5 mm above the substrate surface.

A suspension comprising a solvent and nanoparticles is then applied to an area between the deposition plate and the substrate such that the suspension contacts the deposition plate and substrates and forms a meniscus between the deposition plate and the substrate. The suspension can have 1-50 volume % of nanoparticles, more preferably 20-50 volume %, and even more preferably about 40 volume %. The volume of the suspension can range from about 5 μL to about 30 μL, and preferably 15 μL.

After applying the suspension between the deposition plate and substrate, the motor is actuated to drive the support member and deposition plate to move in a direction opposite the acute angle formed between the deposition plate and the substrate to spread the suspension along the surface of the substrate. The motor can drive the support member to move for a predetermined distance or the length of the substrate over a predetermined rate of speed. The deposition speed can range from 1 μm/s to 200 μm/s, preferably 20-100 μm/s, and even more preferably 60 μm/s. After spreading the suspension on the substrate, the suspension solvent is removed and the formed nanoparticle coated substrate is allowed to dry. Once removal of the solvent has been accomplished, the nanoparticle coated substrate can be removed from the platform.

The method is preferably carried out under ambient conditions ranging from 16-22° C., and more preferably 18° C., and in an environment having a relative humidity ranging from 35-55%.

A method of making a nanoparticle coated substrate using the deposition apparatus 200 described above is also provided herein by way of example, as there are a variety of ways to carry out the method. The method described below can be carried out using the configurations illustrated in FIGS. 2-6 for example, and various elements of these figures are referenced in explaining an example method. The procedure described below is illustrative only and the order of the blocks can change according to the present disclosure. Additional steps may be added or fewer steps may be utilized, without departing from this disclosure.

First a substrate is secured to the platform. After securing the substrate, the deposition plate is placed above the substrate such that an acute angle is formed between the deposition plate and the substrate. Preferably, the acute angle formed by the substrate and deposition plate is greater than 25 degrees, more preferably greater than 45 degrees, and even more preferably the acute angle is 60 degrees. The acute angle is formed at an end of the substrate that is closest to the support member. In at least one embodiment, the deposition plate can be positioned such that it contacts the substrate. In other embodiments, the deposition plate can be suspended above the substrate at while still forming the acute angle. In at least one embodiment, the deposition plate is suspended up to 0.5 mm above the substrate surface. In other embodiments, the deposition plate is suspended from about 40 μm to about 0.5 mm above the substrate surface.

A suspension comprising a solvent and nanoparticles is then applied to an area between the deposition plate and the substrate such that the suspension contacts the deposition plate and substrates and forms a meniscus between the deposition plate and the substrate. The suspension can have 1-50 volume % of nanoparticles, more preferably 20-50 volume %, and even more preferably about 40 volume %. The volume of the suspension can range from about 5 μL to about 30 μL, and preferably 15 μL.

After applying the suspension between the deposition plate and substrate, the motor is actuated to drive the platform to move in a direction opposite the acute angle formed between the deposition plate and the substrate to spread the suspension along the surface of the substrate. The motor can drive the platform to move for a predetermined distance or the length of the substrate over a predetermined rate of speed. The deposition speed can range from 1 μm/s to 200 μm/s, preferably 20-100 μm/s, and even more preferably 60 μm/s. After spreading the suspension on the substrate, the suspension solvent is removed and the formed nanoparticle coated substrate is allowed to dry. Once removal of the solvent has been accomplished, the nanoparticle coated substrate can be removed from the platform.

The method is preferably carried out under ambient conditions ranging from 16-22° C., and more preferably 18° C., and in an environment having a relative humidity ranging from 35-55%.

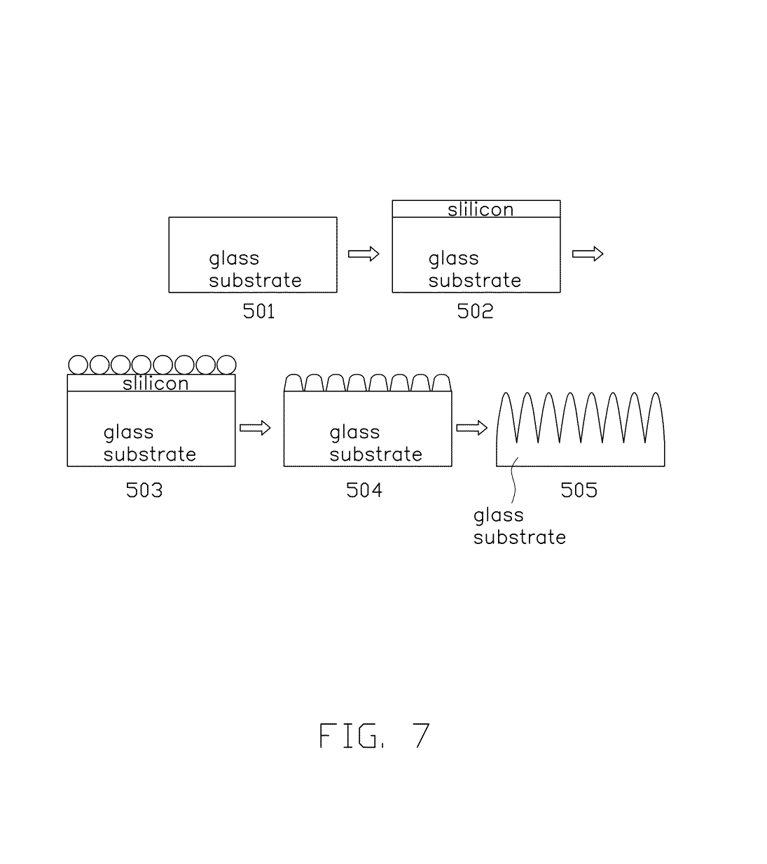

FIG. 7 is a flowchart illustrating an exemplary method of making a substrate with a nanostructured surface. The method 500 is provided by way of example, as there are a variety of ways to carry out the method. The method 500 described below can be carried out using the apparatus illustrated in FIG. 1, for example, and various elements of these figures are referenced in explaining example method 500. Each block shown in FIG. 7 represents one or more processes, methods or subroutines, carried out in the example method 500. Furthermore, the illustrated order of blocks is illustrative only and the order of the blocks can change according to the present disclosure. Additional blocks may be added or fewer blocks may be utilized, without departing from this disclosure. The example method 500 can begin at block 501.

In block 501 a substrate is provided. As shown in 501, a glass substrate is provided. Other substrates can be used without departing the scope of this disclosure.

In block 502, an intermediate silicon mask, which is of a different composition than the substrate, is deposited onto the surface of the substrate.

In block 503, nanoparticles are coated onto the silicon mask using either of methods described above in relation to deposition apparatus 100 or deposition apparatus 200. The coated nanoparticles are preferably the same composition as the substrate.

In block 504, the nanoparticle coated substrate is etched. Etching can be performed using a dry etching technique, such as plasma etching with CH₄, argon, C₄F₈, SF₆, NF₃, Cl₂. BCl₃, ICl, IBr, CHF₃, C₂F₆, Hi, HBr, CF₄, or any combination thereof.

In block 505, substrate etching is continued for a predetermined period of time until the desired surface nanostructure is obtained.

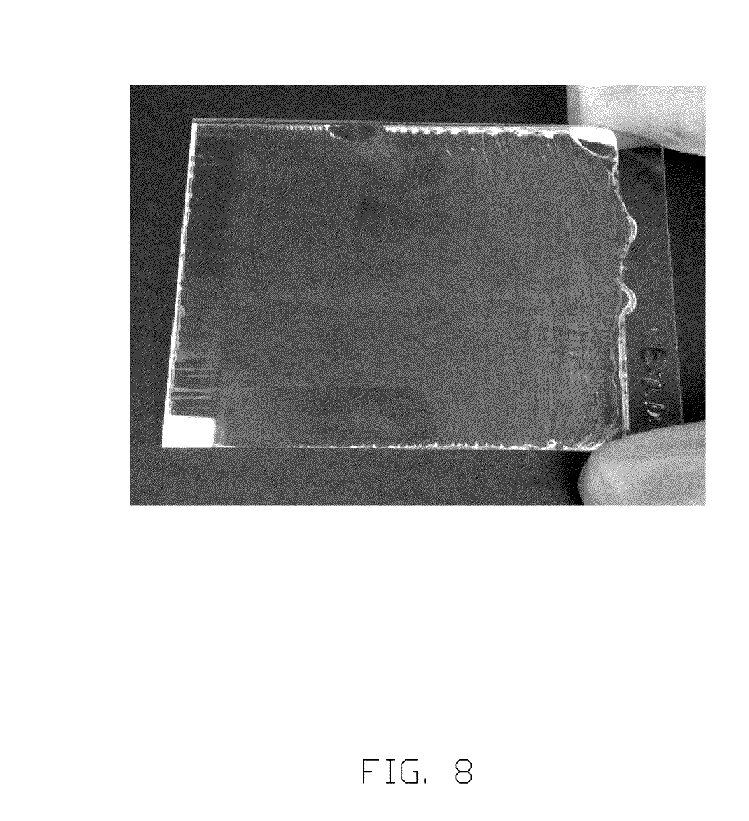

FIG. 8 illustrates an exemplary nanoparticle thin film coated on a substrate. The nanoparticle thin film was prepared by the methods outlined above using SiO₂ nanoparticles. The substrate in FIG. 5 has a length of 5 cm and the deposition occurred over a 10 minute period. As shown, the thin film is uniform and exhibits semi-transparency.

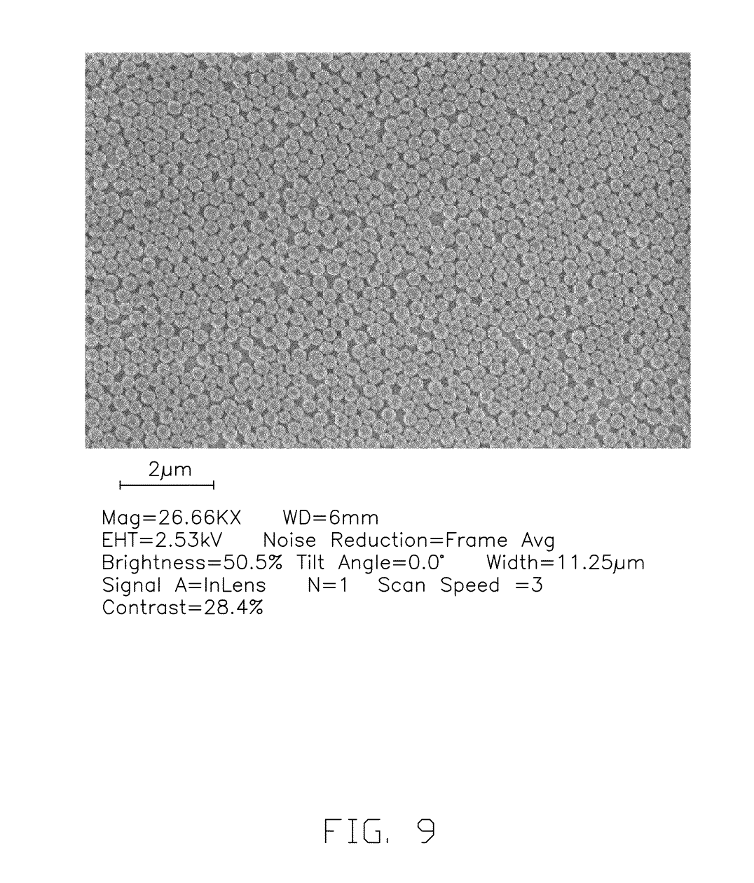

FIG. 9 illustrates a Scanning Electron Microscope (SEM) of a nanoparticle monolayer disposed on a substrate. The spherical SiO₂ nanoparticles range from about 240-360 nm in diameter. As shown, the nanoparticle monolayer exhibits regions of closed packed hexagonal structure with minor areas of dislocations or voids therethrough.

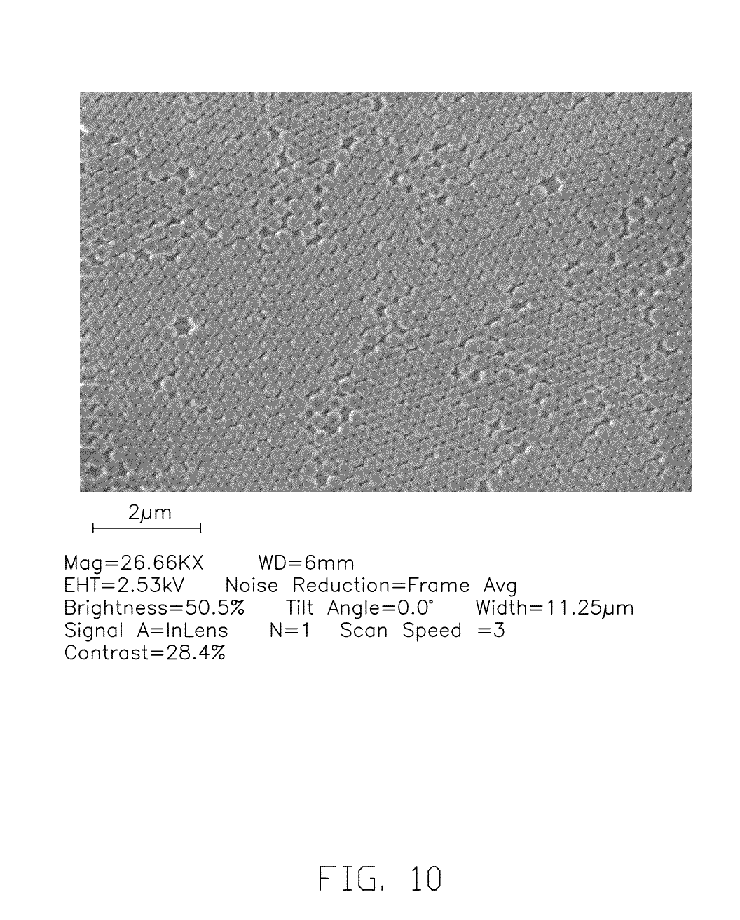

FIG. 10 illustrates an SEM image of another SiO₂ nanoparticle monolayer disposed on a substrate. The spherical nanoparticles range from about 240-360 nm in diameter. As shown, the nanoparticle monolayer exhibits a more highly ordered closed packed hexagonal structure than the nanoparticle monolayer of FIG. 9.

As shown, the monolayer of FIG. 10 exhibits more defined grain boundaries, meaning some line-defects are observed, while in the monolayer of FIG. 9, the lattice domain is smaller, rendering a more random patterning. These differences in lattice types of FIGS. 9 and 10 can be attributed to different variables which affect the self-assembly process, such as temperature, relative humidity, coating speed, particle volume density, etc.

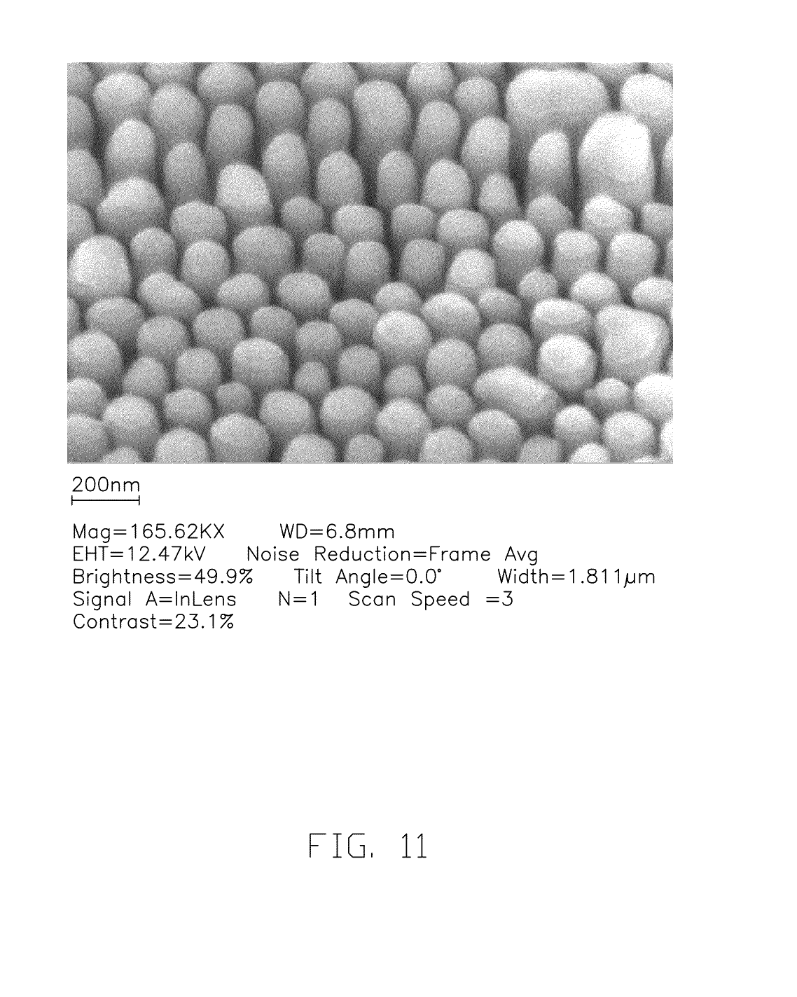

FIG. 11 is an SEM image of an exemplary nanostructured substrate surface as prepared by the method 500 described above wherein the final step is block 504.

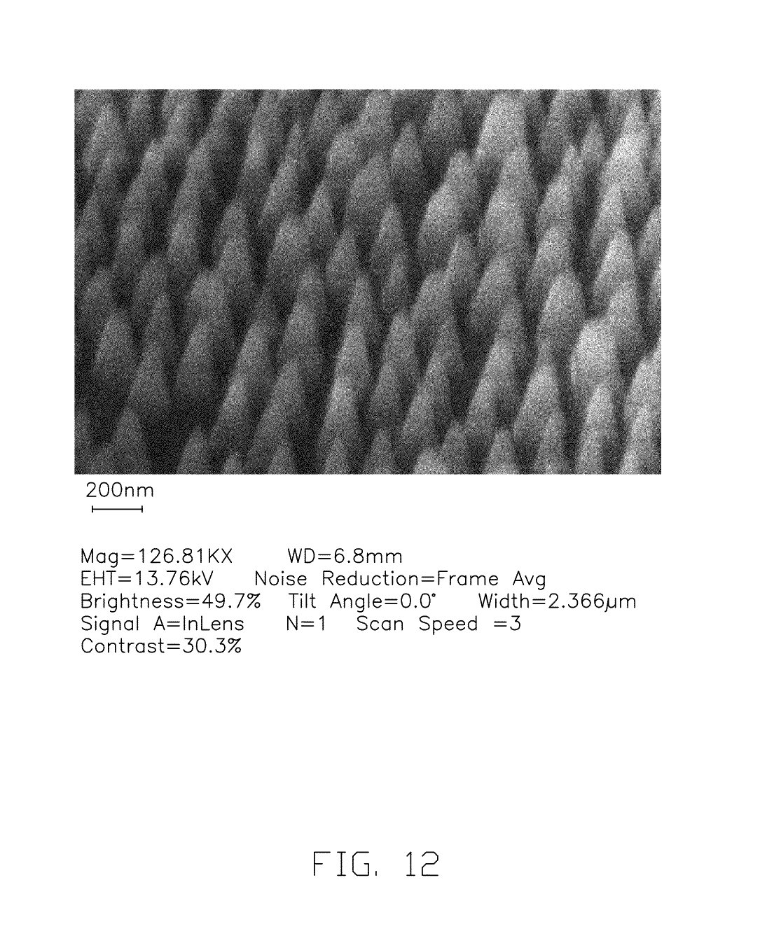

FIG. 12 is an SEM image of another exemplary nanostructured substrate surface as prepared by the method 500 described above wherein the final step block 505.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An apparatus for applying nanoparticles to a surface of a substrate, the apparatus comprising:
a support member;
a deposition plate extending from the support member; and
a platform having a flat surface for receiving a substrate,
wherein the support member and the platform are capable of moving relative to each other, enabling an end of the deposition plate to move across the flat surface of the platform.

2. The apparatus of claim 1, wherein the apparatus further comprises a motor, the motor is coupled to the support member and is configured to drive the support member to move relative to the platform.

3. The apparatus of claim 1, wherein the apparatus further comprises a motor, the motor is coupled to the platform and is configured to drive the platform to move relative to the deposition plate.

4. The apparatus of claim 1, wherein the apparatus further comprises a drive shaft, the support member or the platform is capable of moving along the drive shaft.

5. The apparatus of claim 1, wherein the apparatus further comprises a clamp mounted on the support member, the clamp couples to the deposition plate.

6. The apparatus of claim 1, wherein the deposition plate extends toward the flat surface of the platform at an acute angle greater than 25 degrees.

7. The apparatus of claim 6, wherein the acute angle is 60 degrees.

8. The apparatus of claim 1, wherein the end of the deposition plate physically contacts the substrate when the support member and the platform move relative to each other.

9. The apparatus of claim 1, wherein the end of the deposition plate is suspended above the substrate when the support member and the platform move relative to each other.

10. The apparatus of claim 9, wherein the end of the deposition plate is suspended above the surface of the substrate.

11. A method of coating a substrate with a plurality of nanoparticles using an apparatus, the apparatus comprises a support member, a deposition plate extending from the support member, and a platform having a flat surface for receiving a substrate, the support member and the platform are capable of moving relative to each other, enabling an end of the deposition plate to move across the flat surface of the platform, the method comprising:
securing a substrate on the flat surface of the platform;
forming an acute angle between the deposition plate and the substrate;
applying a suspension comprising a solvent and nanoparticles to an area between the deposition plate and the substrate such that the suspension forms at least one meniscus between the deposition plate and the substrate;
driving the deposition plate to move relative to the platform or driving the platform to move relative to the deposition plate, enabling the suspension to spread on a surface of the substrate; and
removing the suspension solvent on the substrate.

12. The method of claim 11, wherein the suspension comprises about 1%-50% nanoparticles by volume.

13. The method of claims 11, wherein deposition speed of the nanoparticles is range from 1 μm/s to 2001 μm/s.

14. The method of claim 11, wherein the acute angle is greater than 25 degrees.

15. The method of claim 15, wherein the acute angle is 60 degrees.

16. The method of claim 11, wherein the end of the deposition plate is suspended from about 40 m to about 0.5 mm above the substrate surface.

17. The method of claim 11, wherein the end of the deposition plate physically contacts the substrate.

18. The method of claim 11, wherein the method further comprises a step of forming an intermediate silicon mask on the surface of the substrate prior to the step of securing the substrate on the flat surface of the platform; and a step of etching the nanoparticles coated substrate to obtain a nanostructures surface of the substrate after the step of removing the suspension solvent on the substrate.
